(19) United States
(12) Patent Application Publication
(10) Pub. No.: US 2013/0334989 A1
(43) Pub. Date: Dec. 19, 2013

(54) DRIVING DEVICE FOR VIBRATION-TYPE ACTUATOR AND MEDICAL SYSTEM USING SAME

(71) Applicant: CANON KABUSHIKI KAISHA, Tokyo (JP)

(72) Inventor: Kenichi Kataoka, Yokohama-shi (JP)

(21) Appl. No.: 13/915,483

(22) Filed: Jun. 11, 2013

(30) Foreign Application Priority Data
Jun. 15, 2012 (JP) 2012-135447

(51) Int. Cl. H02N 2/00

(52) U.S. Cl. CPC H02N 2/0075
USPC 318/116

(57) ABSTRACT

A driving device for a vibration-type actuator of the present invention is a driving device for driving a vibration-type actuator disposed in a magnetically shielded room. The driving device includes a linear amplifier is configured to receive a signal based on a driving waveform for driving the vibration-type actuator and output a driving voltage to be applied to the vibration-type actuator.

### BACKGROUND OF THE INVENTION

1. Field of the Invention

The present disclosure relates to a driving device for a vibration-type actuator and a medical system using the same. In particular, the disclosure relates to a medical system that includes a magnetic resonance imaging (MRI) apparatus or a magnetoencephalograph (MEG) and to a driving device for a vibration-type actuator operating in the medical system.

2. Description of the Related Art

In recent years, medical robotic devices, such as manipulators, have been studied actively. One typical example is a medical system that uses a magnetic resonance imaging (MRI) apparatus, and the medical system enables a user to control the position of a robotic arm of a manipulator and perform an accurate biopsy and treatment while viewing an MR image. MRI is a technique of providing a site to be measured of a subject (specimen) with a static magnetic field and an electromagnetic wave generated by a specific radio-frequency magnetic field and creating an image by applying the nuclear magnetic resonance phenomenon induced by the provision inside the subject.

Because using high magnetic fields, MRI cannot employ an electromagnetic motor that includes a ferromagnet as a power source for a robotic arm. Thus a vibration-type actuator, typified by an ultrasonic motor, is suitable for the power source. Radio-frequency noise generated by a controller for the vibration-type actuator also has an influence on an MR image, and thus it is necessary to significantly suppress or block the noise from the controller.

Japanese Patent Laid-Open No. 2000-184759 describes a change in the amount of harmonics generated in accordance with a pulse width of a driving waveform of a vibration-type actuator and also illustrates a circuit configuration in which the voltage of a pulse signal is boosted by a transformer. Like in this case, a vibration-type actuator is typically driven by a pseudo sine wave in which the waveform of a pulse voltage is rounded by the use of an inductor element or other elements. Because the waveform is generated based on the pulse voltage, the pseudo sine wave has a waveform in which, in addition to a fundamental wave, harmonics with a frequency that is an integral multiple of that of the fundamental wave is superimposed.

Japanese Patent Laid-Open No. 2011-245202 describes a vibration-type actuator disposed in a tubular measurement portion (bore) that becomes a high magnetic field environment in an MRI apparatus. A controller for the vibration-type actuator is arranged at a maximum distance from the measurement portion of the MRI, and the controller is connected to the vibration-type actuator using an electromagnetically shielded control line.

A known driving circuit illustrated in Japanese Patent Laid-Open No. 2000-184759 can smooth a driving waveform to some extent using a filter characteristic formed by an inductor on the secondary side of the transformer and a damping capacitance of the vibration-type actuator. That is, a harmonic component can be suppressed to some extent. However, because the last output stage is also made of a switching circuit, a waveform immediately after being output from the circuit contains many superimposed harmonic components in principle. Thus when the vibration-type actuator is activated in a magnetically shielded room where the MRI apparatus is placed, a problem arises in that noise is mixed in an MR image. In addition, because such a driving circuit has a non-flat frequency response characteristic, the waveform is also greatly changed by a change in impedance caused by a change in vibration amplitude of the vibration-type actuator. Accordingly, the frequency characteristic of noise may vary depending on the driving condition.

Even when the control line is shielded, as in the Japanese Patent Laid-Open No. 2011-245202, it is difficult to fully remove harmonic noise in a driving waveform.

### SUMMARY OF THE INVENTION

The present application provides a reduction in a harmonic component contained in a driving voltage for a vibration-type actuator.

A vibration-type actuator of the present disclosure is a driving device for driving a vibration-type actuator disposed in a magnetically shielded room. The driving device includes a linear amplifier configured to receive a signal based on a driving waveform for driving the vibration-type actuator and output a driving voltage to be applied to the vibration-type actuator.

Further features of the present invention will become apparent from the following description of exemplary embodiments with reference to the attached drawings.

### BRIEF DESCRIPTION OF THE DRAWINGS

FIG. 1 is a diagram that illustrates a system configuration according to a first embodiment.

FIG. 2 is a diagram that illustrates an example configuration of a vibration-type actuator.

FIG. 3 is a plan view of a piezoelectric member.

FIG. 4 is a diagram that illustrates a variation of a driving circuit according to the first embodiment.

FIG. 5 schematically illustrates an operating waveform of each of portions in the variation of the first embodiment.

FIG. 6 is a diagram that illustrates an example of an optical transmission unit that connects the inside and outside of a magnetically shielded room.

FIG. 7 schematically illustrates an operating waveform of each of portions illustrated in FIG. 6.

FIG. 8 illustrates an example that uses a digital-to-analog converter instead of a differential amplifier illustrated in FIG. 6.

FIG. 9 is a diagram that illustrates an example of the optical transmission unit using optical wavelength division multiplexing.

FIG. 10 is a diagram that illustrates a driving circuit for a vibration-type actuator according to a second embodiment.

FIG. 11 schematically illustrates an operating waveform of each of portions illustrated in FIG. 10.

FIG. 12 is a diagram that illustrates Variation 1 of the driving circuit according to the second embodiment.

FIG. 13 is a diagram that illustrates an example of a circuit configuration of a photoreceiver and its surroundings.

FIG. 14 illustrates a frequency characteristic of a gain in the circuit illustrated in FIG. 12.

FIG. 15 is a diagram that illustrates Variation 2 of the driving circuit according to the second embodiment.

FIG. 16 illustrates a frequency characteristic of a gain in the circuit illustrated in FIG. 15.

FIG. 17 illustrates a frequency characteristic of a gain when the transformer of the circuit illustrated in FIG. 15 uses a toroidal core.

FIG. 18 is a diagram that illustrates a driving circuit for a vibration-type actuator according to a third embodiment.

### DESCRIPTION OF THE EMBODIMENTS

A vibration-type actuator and a device for driving it (driving circuit) according to the present disclosure can be used in a medical system that includes an MRI apparatus or other apparatuses. An MRI apparatus irradiates a specimen with a radio frequency (RF) pulse, and receives an electromagnetic wave generated by the specimen in response to the irradiation using a high-sensitivity RF reception coil. Then the MRI apparatus obtains a magnetic resonance (MR) image of the specimen based on a reception signal from the RF reception coil. The vibration-type actuator and the driving device therefor according to the present invention are not limited to application to the above-described medical system. Both are also applicable to an apparatus or system for measuring physical quantities relating to an electromagnetic wave and magnetism (e.g., magnetic flux density “tesla [T]”, magnetic field strength “A/m,” and electrical field strength “V/m”). Embodiments of the present invention are described below with reference to the drawings.

### First Embodiment

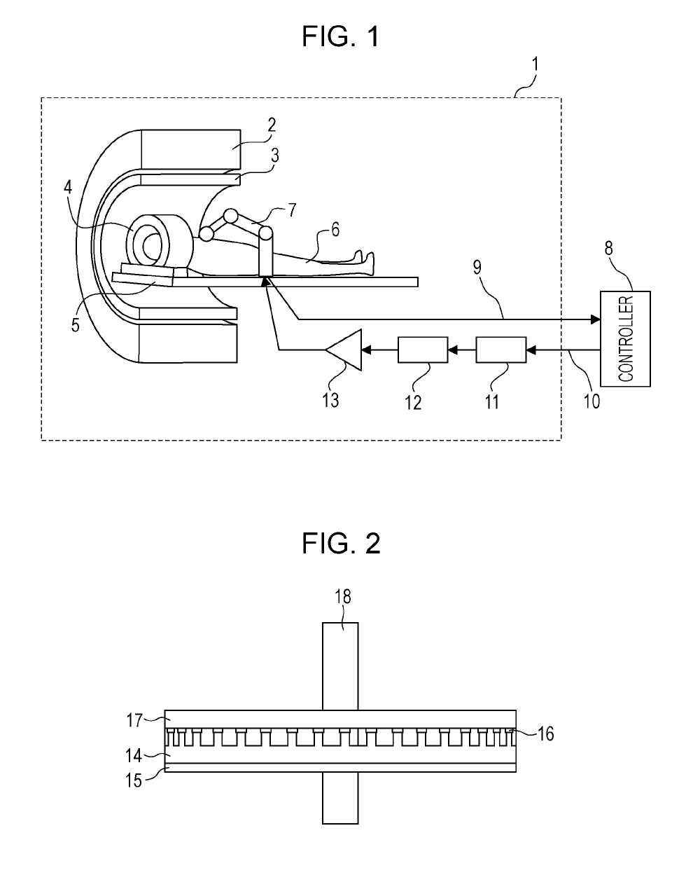

FIG. 1 is a diagram that illustrates a configuration of a medical system according to a first embodiment of the present disclosure. This system performs functional magnetic resonance imaging (fMRI). fMRI is a technique of visualizing changes in blood flow caused by brain and spine activity using an MRI apparatus. This system changes a contact stimulus on a time-series basis by moving a robotic arm using a vibration-type actuator and measures corresponding changes in blood flow inside the brain. Aside from a contact stimulus, various types of stimuli, such as a visual one and an auditory one, are studied as the stimulus used in the system. In particular, when a robotic arm or another tool is moved inside the MRI apparatus, electromagnetic noise produced by a driving source is reduced by magnetically shielding, and members are demagnetized to minimize distortion of a static magnetic field.

### (Basic Configuration of MRI Apparatus)

First, the configuration of a system that includes an MRI apparatus is described as a medical system according to the present embodiment with reference to FIG. 1. The medical system to which the present disclosure is applicable includes at least a measurement unit disposed inside a magnetically shielded room 1 and a controller 8 disposed outside the magnetically shielded room 1.

The MRI apparatus is sensitive in particular to electromagnetic noise in the vicinity of a frequency called the Larmor frequency, which is determined in accordance with a magnetic field strength specific to the apparatus. The Larmor frequency is a frequency of precession of magnetic dipole moment of atomic nuclei inside the brain of a subject 6. For the magnetic field strength 0.2 T to 3 T, which is clinically used by an MRI apparatus in general, the Larmor frequency ranges from 8.5 MHz to 128 MHz. Thus it is necessary to significantly reduce the occurrence of electromagnetic noise in frequencies in that range in devices operating in a magnetically shielded room. However, because the controller 8, in which a central processing unit (CPU) or a field-programmable gate array (FPGA) is used, typically operates with an external clock of approximately 10 MHz to 50 MHz, electromagnetic noise resulting from that clock signal largely overlaps the range of the Larmor frequency when its harmonic waves are included. Because of this, the measurement unit configured to measure a change in weak magnetic field occurring inside the brain is disposed inside the magnetically shielded room 1, which blocks the influences of external noise.

The measurement unit of the MRI apparatus includes at least a superconducting magnet 2 for producing a static magnetic field, a gradient coil 3 for producing a gradient magnetic field to identify a three-dimensional position, an RF coil 4 for irradiating the subject 6 with an electromagnetic wave and receiving the electromagnetic wave, and a table 5 for the subject 6. The RF coil 4 corresponds to a receiving portion. The superconducting magnet 2 and the gradient coil 3 are both cylindrical in actuality, and both are illustrated in FIG. 1 such that their half portions are removed. The RF coil 4 is specialized for measurement of MR imaging inside the brain, and is constructed in a tubular form so as to cover the head of the subject 6 lying on the table 5. The measurement unit of the MRI apparatus produces gradient magnetic fields in various sequences and emits electromagnetic waves in accordance with a control signal from a control portion (not illustrated) disposed outside the magnetically shielded room 1. The outside control portion (not illustrated) obtains various kinds of information on the inside of the brain using a reception signal from the RF coil 4. This control portion, which is used for controlling electromagnetic waves, may be included in the controller 8.

A robotic arm 7 is fixed on the table 5 in the measurement unit. The robotic arm 7 can move with three degrees of freedom of two joints and pivoting of a base, and can cause a contact ball at the tip of the arm to be pressed in contact with any location of the subject 6 by any pressing force and can provide the subject 6 with time-series stimuli. Each of the joints and the pivoting base of the robotic arm 7 is equipped with the vibration-type actuator illustrated in FIG. 2, a rotation sensor, and a force sensor (both of which are not illustrated). A signal of each of the rotation sensor and the force sensor is converted into an optical signal, and it is transmitted to the controller 8, which is disposed outside the magnetically shielded room 1, through an optical fiber 9. Each of the joints of the robotic arm 7 is equipped with the vibration-type actuator, and the vibration-type actuator is a mechanism for directly driving the joint. Thus the entire stiffness is high, and an operation of the robotic arm 7 can provide the subject 6 with various stimuli in a wide frequency range. The main structure of the robotic arm 7, including the vibration-type actuator, is made of a nonmagnetic material, and it is designed to minimize interference with a static magnetic field produced by the superconducting magnet 2.

In actual measurement, first, the subject 6 is asked to grab the tip of the robotic arm 7 with his or her hand and not to move his or her arm as much as possible. Then, the magnitude of a force, the pattern of the direction thereof, and other elements are changed on a time-series basis while the force is produced by the robotic arm 7, and changes in blood flow inside the brain of the subject 6 are measured. For such a measurement, because it is necessary to continuously exert the force, driving the robotic arm 7 continues.

The controller 8 outputs a driving signal (driving waveform) for driving the vibration-type actuator in accordance with a result of comparison between a time-series signal for proving the subject 6 with a stimulus with a preset route and a preset pressing force and information from the rotation sensor and the force sensor. The driving signal is a pulse signal in which a sine wave is pulse-width modulated. This pulse-width modulated signal is converted into an optical signal inside the controller 8, and the optical signal is transmitted into the magnetically shielded room 1 through an optical fiber 10. The optical fiber 10 corresponds to an optical transmission unit.

A photoreceiver 11 converts an optical signal output from the controller 8 into an electrical signal. A low-pass filter 12 removes a harmonic component from a pulse-width modulated signal output from the photoreceiver 11, and outputs a smooth sinusoidal signal. Then a linear amplifier 13 linearly amplifies the sinusoidal signal output from the low-pass filter 12 and applies it to the vibration-type actuator. The linear amplifier 13 corresponds to a linear amplification unit.

### (Configuration of Vibration-Type Actuator)

The configuration of the vibration-type actuator applicable to the present disclosure is described below.

FIG. 2 is a diagram that illustrates an example configuration of the vibration-type actuator. The vibration-type actuator in the present embodiment includes a vibrator and a driven member.

The vibrator includes an elastic member 14 and a piezoelectric member 15. The piezoelectric member 15 is a piezoelectric element (electrical-to-mechanical energy conversion element). The elastic member 14 has a ring structure that has the shape of the teeth of a comb on one surface. The piezoelectric member 15 is attached to another surface of the elastic member 14. The top surface of the protrusions of the shape of the comb teeth of the elastic member 14 is attached to a friction member 16. The driven member is a rotor 17. The rotor 17 has a disc-shaped structure that is pressed into contact with the elastic member 14 with the friction member 16 disposed therebetween by a pressing unit (not illustrated).

When an alternating voltage (driving voltage) is applied to the piezoelectric member 15 in the vibration-type actuator, vibration occurs in the elastic member 14. This vibration produces a frictional force between the rotor 17 and the friction member 16, and the frictional force rotates the rotor 17 relative to the elastic member 14. A rotation shaft 18 is fixed on the center of the rotor 17, and rotates together with the rotor 17. In the present embodiment, this vibration-type actuator is arranged on each of the two joints, which are indicated by circles in FIG. 1, and the connection between the table 5 and the base of the robotic arm 7 to enable rotation of each of the two joints and pivot motion of the overall portion.

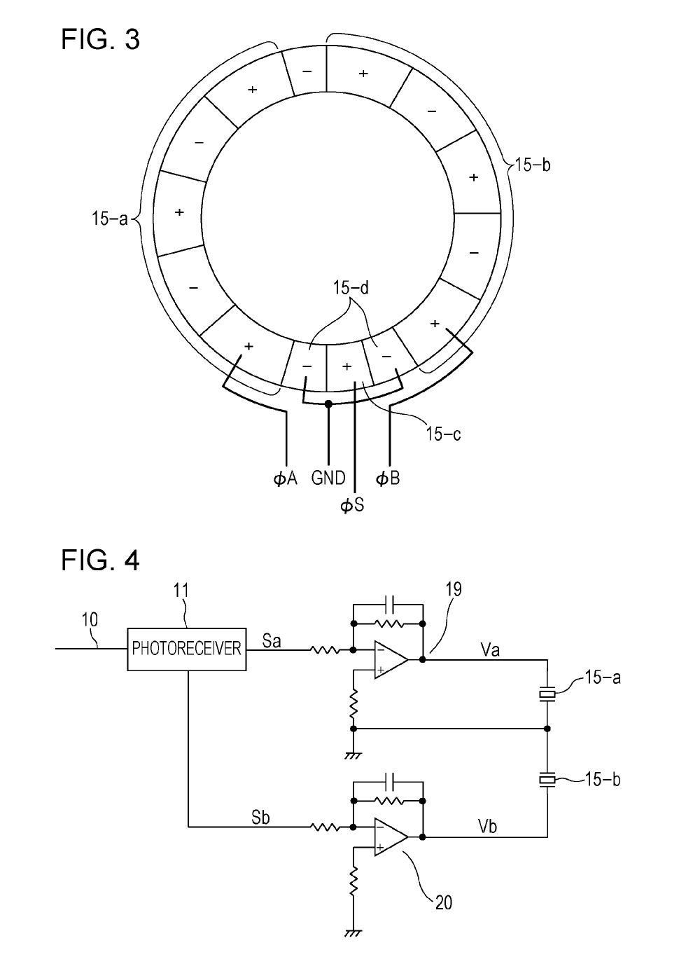

FIG. 3 is a plan view of the piezoelectric member 15. The piezoelectric member 15 includes a piezoelectric portion and a ring-shaped electrode on the piezoelectric portion. The electrode includes a plurality of partitioned electrodes. The signs + and − in FIG. 3 indicate directions of polarization of the piezoelectric portion in a region corresponding to each of the electrodes. The back side of the piezoelectric member 15 is a single electrode whose entire surface is allowed to pass electricity. The electrodes are broadly classified into three groups: electrodes 15-a and 15-b for causing vibration, an electrode 15-c for detecting vibration, and electrodes 15-d for connecting to the ground. The groups are electrically independent of one another, and the electrodes in one group are connected using conductive paint or other paint (not illustrated). The electrodes 15-d for connecting to the ground are electrically connected to the elastic member 14, which is attached to the back side thereof, using conductive paint. Alternating voltages φA and φB having different phases are applied to the electrodes 15-a and 15-b for causing vibration, respectively, and a travelling oscillatory wave that travels along the circumference of the ring occurs in the elastic member 14.

### (Basic Configuration of Driving Circuit for Vibration-Type Actuator)

Referring back to FIG. 1, a driving circuit that is a device for driving the vibration-type actuator according to the present embodiment is described next in detail. In the present embodiment, the driving circuit for the vibration-type actuator includes the photoreceiver 11, low-pass filter 12, and linear amplifier 13. The controller 8 is connected to the driving circuit, receives and outputs an optical signal from and to the driving circuit, and functions as a waveform generating unit configured to generate a driving signal (driving waveform). The linear amplifier 13 includes a Class A or AB amplifier, and outputs a waveform with small harmonic distortion.

As described above, in the present embodiment, a driving signal output from the controller 8 is a pulse signal in which a sine wave is pulse-width modulated, is converted into an optical signal inside the controller 8, and the optical signal is transmitted into the magnetically shielded room 1 through the optical fiber 10, which is the optical transmission unit.

The photoreceiver 11 converts an optical signal output from the controller 8 into an electrical signal. The low-pass filter 12 removes a harmonic component from the pulse-width modulated signal output from the photoreceiver 11, and outputs a smooth sinusoidal signal. That is, the low-pass filter 12 removes at least a frequency component at or above the modulation frequency of the pulse signal in which the sine wave is pulse-width modulated. The above-described pulse signal, which has a waveform in which a sine wave is pulse-width modulated (PWM), may have waveforms obtained by other pulse modulation schemes. For example, an original sine wave is obtainable from a waveform produced using pulse-density modulation (PDM), typified by ΔΣ modulation, or pulse-amplitude modulation (PAM) when its radio-frequency component is removed using a filter.

After that, the linear amplifier 13, which is the linear amplification unit, receives, as a signal based on a driving waveform output from the low-pass filter 12, a sine wave (analog signal) in which a frequency component at or above the modulation frequency of a pulse-width modulated signal is removed. The linear amplifier 13 linearly amplifies the input sine wave, and applies it to the vibration-type actuator. Thus there are substantially no harmonics resulting from the linear amplifier 13. In the case of the above-mentioned PDM, it is a scheme similar to the frequency modulation, and no modulation frequency exists. The above-described example uses a sine wave in which a frequency component at or above the modulation frequency of a pulse-width modulated signal is removed. A low-pass filter that removes a frequency higher than that of an original sine wave may also be used. For example, in the case of PDM, the use of a low-pass filter that removes a frequency twice or more than the frequency of an original sine wave enables waveform distortion of radio frequencies to be removed.

However, because there is a limit to the performance of a low-pass filter, it is impossible to completely eliminate waveform distortion of radio frequencies caused by pulse modulation, such as pulse-width modulation. The Larmor frequency is determined by the magnitude of a magnetic flux density of a magnetic field formed by the superconducting magnet 2 and gradient coil 3. Because the Larmor frequency is linked to a change in the magnetic flux density, when a gradient magnetic field is given, the Larmor frequency has a certain frequency range.

In the present embodiment, selecting the modulation frequency such that the above-described Larmor frequency range and a frequency that is an integer multiple of the modulation frequency of the above-described pulse-width modulation do not overlap each other can further reduce the mixing of noise into an MR image. In particular, when a driving waveform is a pulse signal in which a sine wave is pulse-width modulated or pulse-amplitude modulated, it is preferable that a frequency that is an integer multiple of the modulation frequency of that pulse signal does not overlap the Larmor frequency range. That is, when a signal based on a driving waveform is a sine wave that contains a harmonic, it is preferable to set the frequency such that the harmonic does not overlap the Larmor frequency range. A sine wave that contains a harmonic corresponds to a pseudo sine wave.

Setting the frequency of the driving voltage for the vibration-type actuator such that other harmonic components caused by pulse-width modulation do not overlap the Larmor frequency range is also effective for noise suppression. Examples of the other harmonic components caused by pulse-width modulation include a frequency component that is an integer multiple of the driving frequency, the sum of a frequency component that is an integer multiple of the driving frequency and a frequency component that is an integer multiple of the pulse-width modulation frequency, and the difference therebetween.

In addition, when the driving waveform is a signal in which a sine wave is digital-to-analog converted, it is preferable that a frequency that is an integer multiple of the sampling frequency of the D/A conversion does not overlap the Larmor frequency range.

A typical method for controlling a speed of the vibration-type actuator is controlling the driving frequency. As described above, when a frequency range of the driving waveform at which a harmonic caused to occur by pulse-width modulation is in the vicinity of the Larmor frequency range is set in advance and the frequency of the driving voltage is controlled outside the set frequency range, the mixing of noise into an MR image can be suppressed. When the mixing of noise into an MR image is permitted to some extent in sites other than a site of interest, the above-described Larmor frequency range may be narrowed to the Larmor frequency in the vicinity of the site of interest.

### (Variation 1 of Driving Circuit in First Embodiment)

Variation 1 of the driving circuit in the present embodiment is described next with reference to FIG. 4. For the above-described basic configuration example, an output of the photoreceiver 11 is input into the low-pass filter 12, and the low-pass filter 12 removes the modulation frequency of a PWM signal. For the present variation, the photoreceiver 11 also has a filter characteristic. FIG. 4 illustrates a variation of the driving circuit in the present embodiment. In the present variation, the photoreceiver 11 receives pulse signals Pa and Pb, each of which a sine wave is pulse-width modulated, through the optical fiber. The photoreceiver 11 in the present variation has a low-pass filter function, removes the modulation frequency of each of the PWM signals, and outputs two sinusoidal signals Sa and Sb having different phases.

The driving circuit of the present variation includes inverting linear amplifiers 19 and 20 each having a bandwidth restricted using a capacitor. If the photoreceiver 11 has an insufficient filter characteristic, signals with the above-described modulation frequency component may remain in each of the sinusoidal signals Sa and Sb (signal based on the driving waveform). To address this, in the present variation, the linear amplifiers 19 and 20, each of which includes the capacitor, further attenuate the modulation frequency components, and alternating voltages Va and Vb being the driving voltages are applied to the piezoelectric members 15-a and 15-b, respectively. If the filter characteristic of the photoreceiver 11 is sufficiently limited to a frequency range in advance, the linear amplifiers 19 and 20 may not have the configuration in which the bandwidth is limited using the capacitor, unlike the present variation.

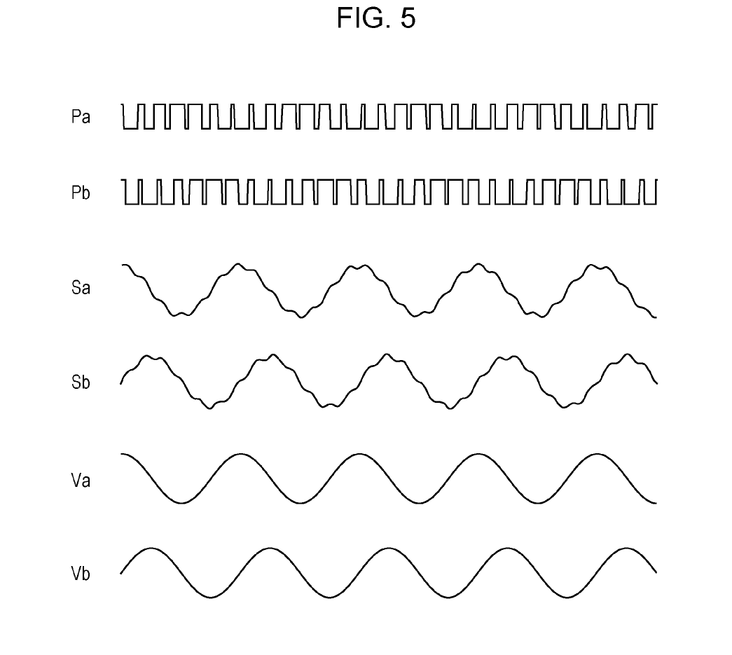

FIG. 5 schematically illustrates distortion of an operating waveform in each of the portions illustrated in FIG. 4. FIG. 5 reveals that the signals with the modulation frequency components of the pulse signals Pa and Pb in which sine waves are pulse-width modulated remain in the signals Sa and Sb, whereas they are not substantially contained in the alternating voltages Va and Vb being the driving voltages to be applied to the piezoelectric members 15-a and 15-b. However, even in this case, because there is a possibility that a weak electromagnetic wave may affect an MR image, it is preferable that the Larmor frequency range and a frequency that is an integer multiple of the pulse-width modulation frequency do not overlap each other.

### (Variation 2 of Driving Circuit in First Embodiment)

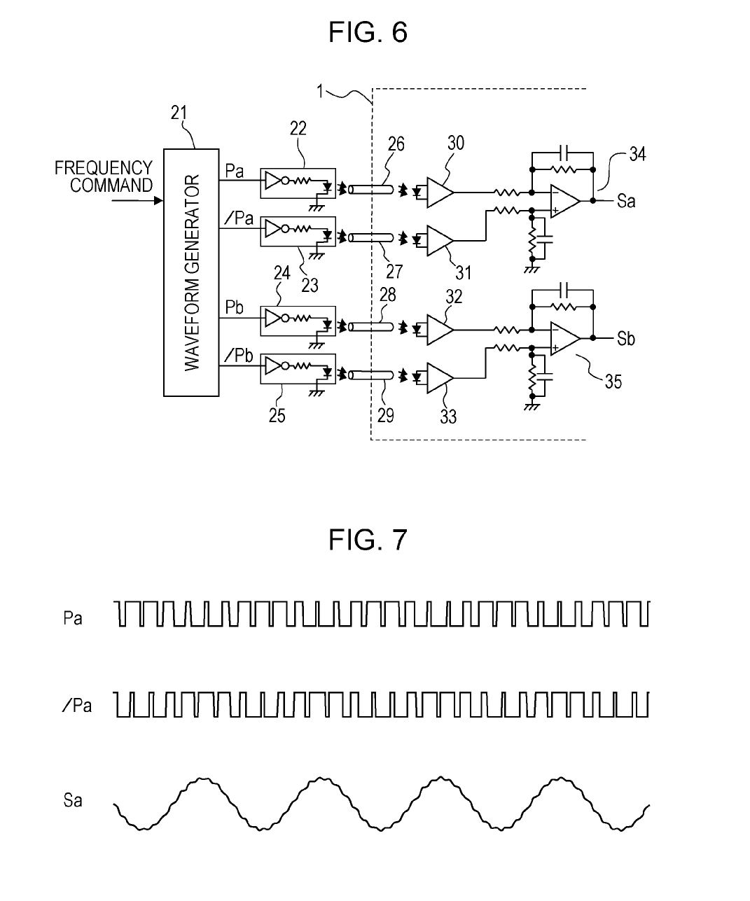

Variation 2 of the driving circuit in the present embodiment is described next with reference to FIG. 6. FIG. 6 illustrates signal communication between the inside and outside of the magnetically shielded room 1 using optical fibers (optical transmission unit). A waveform generator 21 generates four-phase pulse signals Pa, /Pa, Pb, and /Pb having different phases in which sinusoidal signals corresponding to a frequency command from a command unit (not illustrated) are pulse-width modulated. The waveform generator 21, command unit, and transmitters 22 to 25 are disposed inside the controller 8 illustrated in FIG. 1.

The phases of their sinusoidal signals pulse-width modulated into the pulse signals Pa and Pb and those of the pulse signals /Pa and /Pb are inverted, respectively. The sinusoidal signals before the pulse-width modulation of the pulse signals Pa and Pb are 90° out of phase with each other. The transmitters 22, 23, 24, and 25 convert their respective pulse-width modulated signals into optical signals. The optical signals output from the transmitters 22, 23, 24, and 25 are transmitted into the magnetically shielded room 1 through optical fibers 26, 27, 28, and 29, respectively. Receivers 30, 31, 32, and 33 convert the optical signals output through the optical fibers 26, 27, 28, and 29 into electrical signals, respectively, and output them as TTL-level pulse signals.

Differential amplifiers 34 and 35 amplify the difference between signals output from the receivers 30 and 31 and that between signals output from the receivers 32 and 33, respectively, and have a filter characteristic of removing a frequency component at or above a harmonic component relating to the modulation frequency of an input pulse-width modulated signal. That is, in the present variation, the differential amplifier 34 functions as a low-pass filter. In the present variation, the receivers 30 and 31 and the differential amplifier 34 constitute the photoreceiver.

FIG. 7 schematically illustrates an operating waveform of each of the portions illustrated in FIG. 6. FIG. 7 reveals that the configuration using the differential amplifiers, as in the present variation, enables the modulation frequency component of pulse-width modulation is cancelled. Thus even with a relatively gradual filter characteristic, harmonic distortion can be reduced. FIG. 7 also reveals that, for the signal Sa, the modulation frequency component of pulse-width modulation is cancelled, but a frequency component in the vicinity of its double frequency remains. This double frequency component can be reduced by, for example, connecting the linear amplifiers 19 and 20, each of which includes a capacitor, as described in Variation 1, to the output sides of the differential amplifiers.

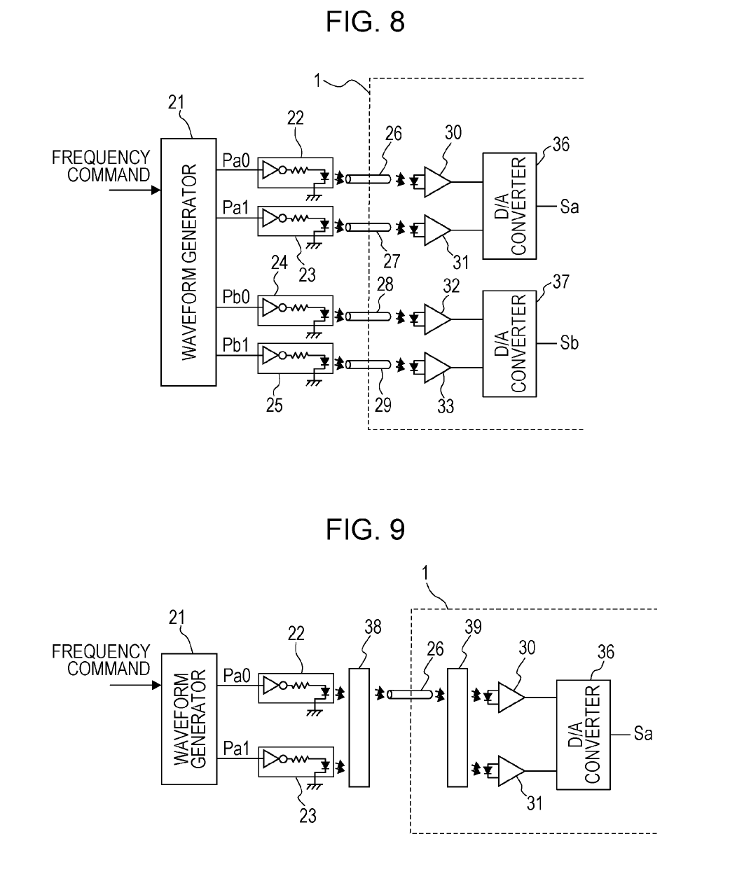

In the present embodiment, as illustrated in FIG. 8, D/A converters may be used in place of the differential amplifiers illustrated in FIG. 6. D/A converts 36 and 37 are 2-bit D/A converters. The waveform generator 21 outputs two-phase sinusoidal signals represented as 2-bit, in place of pulse signals in which four-phase sine waves are pulse-width modulated. The waveforms of the sinusoidal signals are generated as 2-bit parallel signals Pa0 and Pa1 and 2-bit parallel signals Pb0 and Pb1, and they are transmitted to the D/A converts 36 and 37 through the optical fibers 26, 27, 28, and 29. The D/A converts 36 and 37 are configured such that, when an input changes, each of the D/A converts 36 and 37 immediately changes the value of an analog signal to be output. Each of the D/A converts 36 and 37 includes a low-pass filter that removes a frequency component at or above the frequency of the above-described sinusoidal signal, and outputs a sine wave having a smooth waveform. The D/A converts 36 and 37 illustrated in FIG. 8 operate on an input of a parallel signal input. Instead, a multi-bit signal may be transmitted using a publicly known D/A converter operating on a serial signal input.

### (Optical Transmission Unit)

An optical transmission unit applicable to the present application is described below. The optical transmission unit is a waveform transmission unit, and is a unit configured to transmit an optical signal converted into light. The configuration other than the portion relating to optical transmission is substantially the same as that in FIG. 8, and the description thereof is omitted. FIG. 9 illustrates an example of the optical transmission unit using optical wavelength division multiplexing. When it is necessary to connect the inside and outside of the magnetically shielded room 1 using many signal lines, the number of optical fibers is increased. To address this, in the present embodiment, different wavelengths of light beams are used for individual signals, the light beams are combined, and the combined light is separated by wavelength by a photo detector. This enables many signals to be transmitted using a single optical fiber. An optical combining unit 38 combines light beams having different wavelengths from the transmitters 22 and 23, and outputs the combined light. An optical splitting unit 39 separates the light output through the optical fiber 26 by wavelength, and outputs the light beams to the receivers 30 and 31.

In the present embodiment, a signal to be input into the linear amplifier may be produced using an output of a publicly known sine wave oscillator, such as a Wien bridge. This enables digital signals to be completely eliminated, and is effective for an application sensitive to noise. Because the linear amplifier ideally amplifies an input signal, it is an ideal driving circuit for driving the vibration-type actuator using a sine wave. Because the Wien bridge is an analog oscillator and radio-frequency noise is small, it may be disposed inside the magnetically shielded room 1.

The above description illustrates an example that uses the optical transmission unit, such as an optical fiber, to transmit signals between the inside and outside of the magnetically shielded room 1. However, in the present application, a waveform transmission unit configured to not only transmit light after converting a signal into the light but also transmit an electrical signal without conversion may also be used. In this case, a waveform generating unit may be disposed inside a magnetically shielded room.

As described above, in the present embodiment, a driving voltage to be applied to the vibration-type actuator is output by the linear amplifier, a harmonic component contained in the driving voltage is thus reduced, and noise of the harmonic component is suppressed. Because an output impedance of the linear amplifier is low, even if the impedance characteristic of the vibration-type actuator changes, a change in waveform of the driving voltage applied to the vibration-type actuator is small. Thus if the driving voltage applied to the vibration-type actuator contains the harmonic component, an increase or decrease in harmonic component caused by a change in the driving state of the vibration-type actuator can be suppressed, and stable measurement is obtainable.

With the method in which an output of the linear amplifier is directly connected to the vibration-type actuator, common-mode noise from the power supply line may be mixed. However, the use of a battery as the power supply for the circuit inside the magnetically shielded room 1 can avoid noise mixing through the power supply line.

The use of the vibration-type actuator of the present embodiment in measuring movie by the MRI apparatus can suppress flicker and the like in MR images because noise resulting from differences in operations of the vibration-type actuator is small. This facilitates a doctor who is a user performing medical practice while watching movie in real time.

Because changes in conditions among MR images are small, relative comparison is easy. Thus the performance of fMRI measurement of evaluating functions of the brain tissue and the like from changes among MR images and the like is enhanced. Moreover, because the occurrence of noise can be reduced, when the vibration-type actuator is driven in the vicinity of the MRI apparatus, MR images having noise smaller than before are obtainable. The simplification of shielding measures on the vibration-type actuator enables more compact configuration of the medical system.

In the present embodiment, a case where the vibration-type actuator is driven during the running of the MRI apparatus being the medical system is described. Similar advantages are also obtainable from an apparatus placed inside a magnetically shielded room with the aim of measuring electromagnetic waves or magnetism. For example, a magnetoencephalograph (MEG) or the like measures a weak magnetic field using a current passed by signal transmission in neurons inside the brain of a subject. An MEG is often used as a complement to fMRI measurement, and is also used with the aim of examining responses to a stimulus to the subject described above. Accordingly, an MEG needs to block the mixing of electromagnetic noise from the outside as much as possible, as in the case of an MRI apparatus, and the use of the present embodiment enables an MEG to conduct measurement with small noise.

In the present embodiment, the filter has the configuration in which a portion has a low-pass filter characteristic to suppress noise. A band-stop filter that suppresses the Larmor frequency range may also be used.

### Second Embodiment

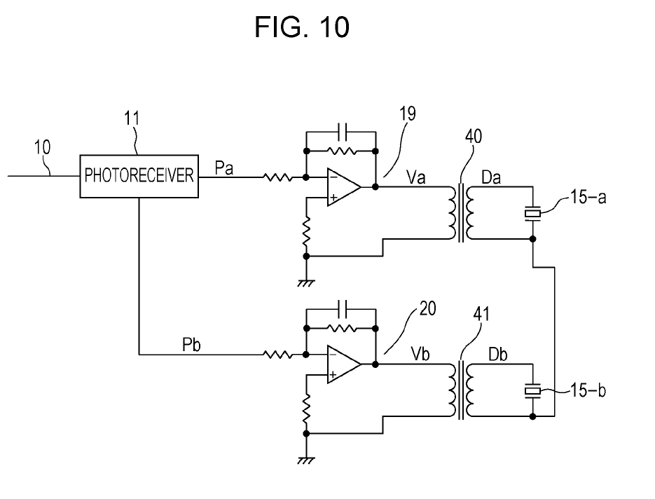

A second embodiment of the present application is described next. FIG. 10 illustrates a driving circuit for a vibration-type actuator according to the second embodiment. In the present embodiment, transformers are disposed between the linear amplifiers 19 and 20 and the electrodes 15-a and 15-b of the piezoelectric member 15 of the vibration-type actuator, and the circuit is insulated from the ground. That is, the primary sides of the transformers are connected to the linear amplifiers, whereas the secondary sides of the transformers are connected to the vibration-type actuator. Driving voltages output from the linear amplifiers are applied to the vibration-type actuator through the transformers. Thus common-mode noise mixing through the power supply lines of the linear amplifiers 19 and 20 can be prevented to some extent from entering the vibration-type actuator.

The configuration of the driving circuit illustrated in FIG. 10 is the one in which transformers 40 and 41 are added to the circuit configuration in FIG. 4. Operations of the photoreceiver 11 are different from those in FIG. 4. The photoreceiver 11 in FIG. 4 has a low-pass filter characteristic, and thus an output signal has a waveform of a substantially sine wave in which a signal with a modulation frequency component of pulse-width modulation is superimposed. The photoreceiver 11 in the present embodiment outputs the pulse signals Pa and Pb, each of which a sine wave is pulse-width modulated.

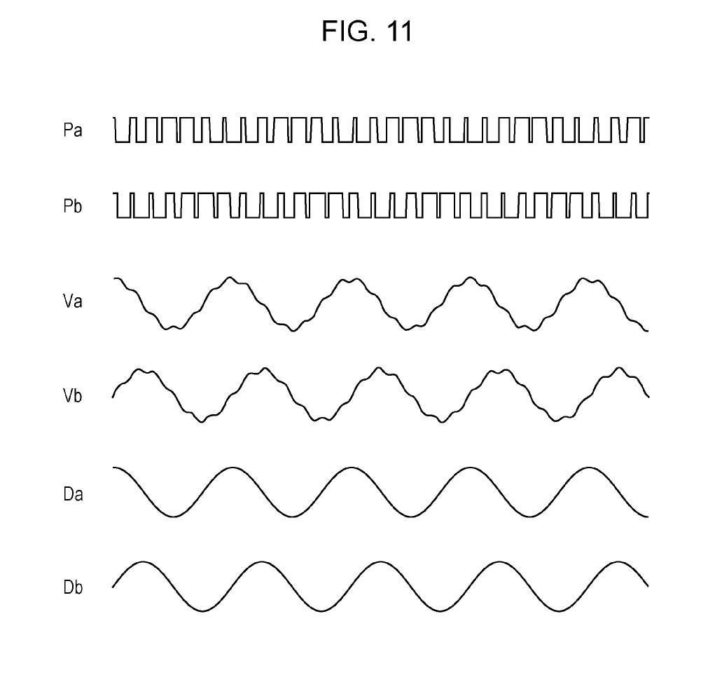

FIG. 11 schematically illustrates an operating waveform of each of the portions illustrated in FIG. 10. Each of the pulse signals Pa and Pb is a pulse signal in which a sine wave is pulse-width modulated, and the high level and low level of each of the pulse signals Pa and Pb have the same magnitude and has different signs.

The linear amplifiers 19 and 20 each having a capacitor have a low-pass filter characteristic. Each of output signals Va and Vb is a sine wave in which a signal with a modulation frequency of pulse-width modulation is superimposed. Each of signals Da and Db on the secondary sides of the transformers 40 and 41 (adjacent to the electrodes 15-a and 15-b of the piezoelectric member) is a smooth sine wave in which the modulation frequency component of pulse-width modulation is eliminated. This is because the modulation frequency component of pulse-width modulation is removed by the low-pass filter characteristic mainly determined by the leakage inductance of the transformers 40 and 41 and the damping capacitance of the piezoelectric members 15-a and 15-b. Setting the leakage inductance of the transformers in this way can simplify the filter configuration. In the above example, filters are arranged in transformers and in portions before the transformers. A filter may also be arranged after a transformer.

### (Variation 1 of Driving Circuit in Second Embodiment)

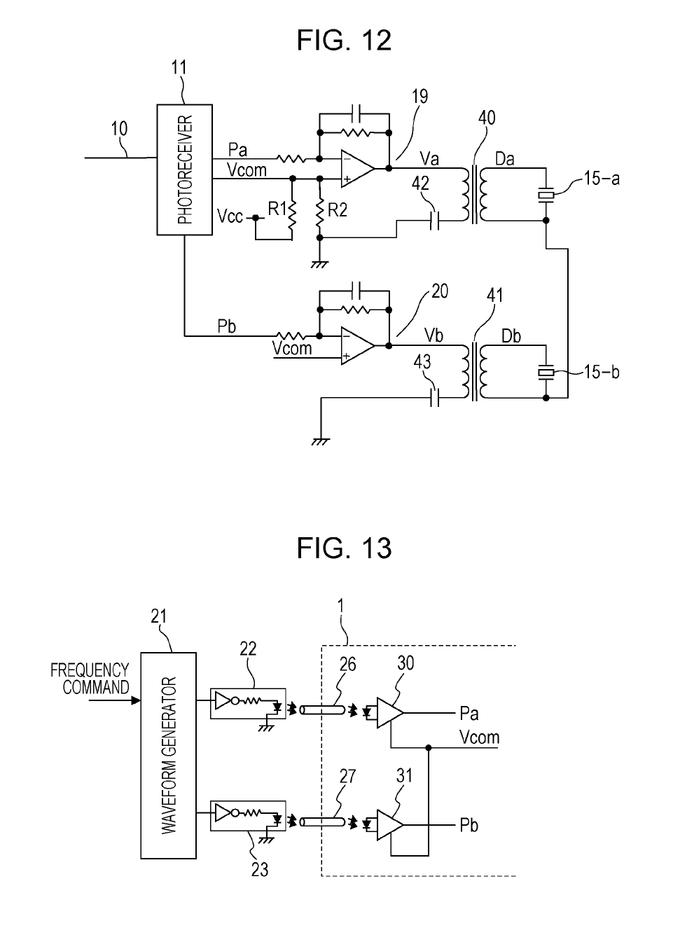

Variation 1 of the driving circuit in the present embodiment is described next. FIG. 12 illustrates a variation of the driving circuit according to the second embodiment. Typically, an output of each of the linear amplifiers has an offset voltage even when an input voltage is 0 volt. Thus when the linear amplifier is connected to the primary side of the transformer, as illustrated in FIG. 10, and is made to operate with no current limitations, a large current may pass in an output, and this may cause degradation in the transformer and linear amplifier. Even when the offset voltage is adjusted to 0 volt, it is necessary to have both positive and negative power supplies as the power supply to the linear amplifiers, and thus the size of the apparatus may be large. Possible approaches to this issue are providing the linear amplifier with a current limiting circuit and disposing a resistor in series on the primary side of the transformer to limit a direct current. However, these approaches may lead to an increase in power consumption when the vibration-type actuator is inactive. Accordingly, in this variation, a circuit configuration that limits a current while suppressing power consumption is described.

The driving circuit illustrated in FIG. 12 is the one in which direct currents passing on the primary sides of the transformers 40 and 41 are blocked by capacitors 42 and 43 connected in series to the primary sides of the transformers. This enables the linear amplifiers to be operable with a single power supply (voltage Vcc).

Operations in the driving circuit in FIG. 12 are described below. The voltage Vcc is the power supply voltage for the linear amplifiers 19 and 20. The voltage Vcc is divided by resistors R1 and R2, a common voltage Vcom is produced, and the common voltage Vcom is input into the positive input of each of the linear amplifiers 19 and 20 and into the common voltage terminal for setting a low-level voltage of an output signal of the photoreceiver 11.

FIG. 13 illustrates an example of a circuit configuration of the photoreceiver 11 and its surroundings. The photoreceiver 11 in FIG. 12 is made up of two receivers 30 and 31 in FIG. 13, and the optical fiber 10 is made up of two optical fibers 26 and 27. Because input signals are input from the waveform generating unit through the optical fibers 26 and 27, even with pulse signals of the ground level outside the magnetically shielded room 1, the pulse signals Pa and Pb of the common voltage Vcom level can be produced.

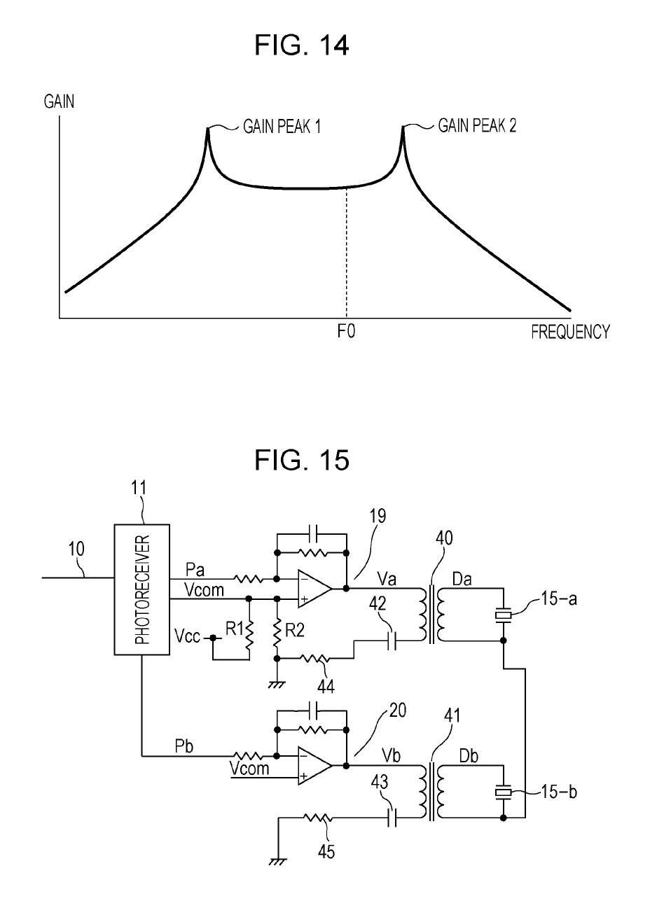

FIG. 14 illustrates a frequency characteristic of a gain (that is, frequency response characteristic between the input and output of the transformer) from the input voltage Va to the output signal Da of the transformer 40 in the circuit illustrated in FIG. 12. Gain peak 1 caused by resonance between the capacitors 42 and 43 and the primary-side inductances of the transformers 40 and 41 resulting from the capacitors 42 and 43 disposed with the aim of blocking a direct current appears in the gain characteristic. Gain peak 2 caused by resonance between the leakage inductances of the transformers 40 and 41 and the damping capacitances of the piezoelectric members 15-a and 15-b also appears in the gain characteristic. F0 is the fundamental frequency of a sine wave applied to the piezoelectric members 15-a and 15-b. This characteristic indicates that the influences of a sharp load change of the vibration-type actuator, a change in driving voltage, and the like lead make the circuit characteristic vibrational, and this may be a factor of the occurrence of noise.

To address this issue, a first measure is forming a waveform in a pulse-width modulation waveform generator (not illustrated) such that sharp voltage applications are avoided, including in a startup and a stop, and the amplitude of a voltage applied to the vibration-type actuator gradually changes.

A second measure is devising the circuit such that a peak of the gain characteristic is sufficiently small. This measure can avoid the influences of a sharp load change that would be difficult to be handled only by the first measure. The second measure is described with reference to FIG. 15.

### (Variation 2 of Driving Circuit in Second Embodiment)

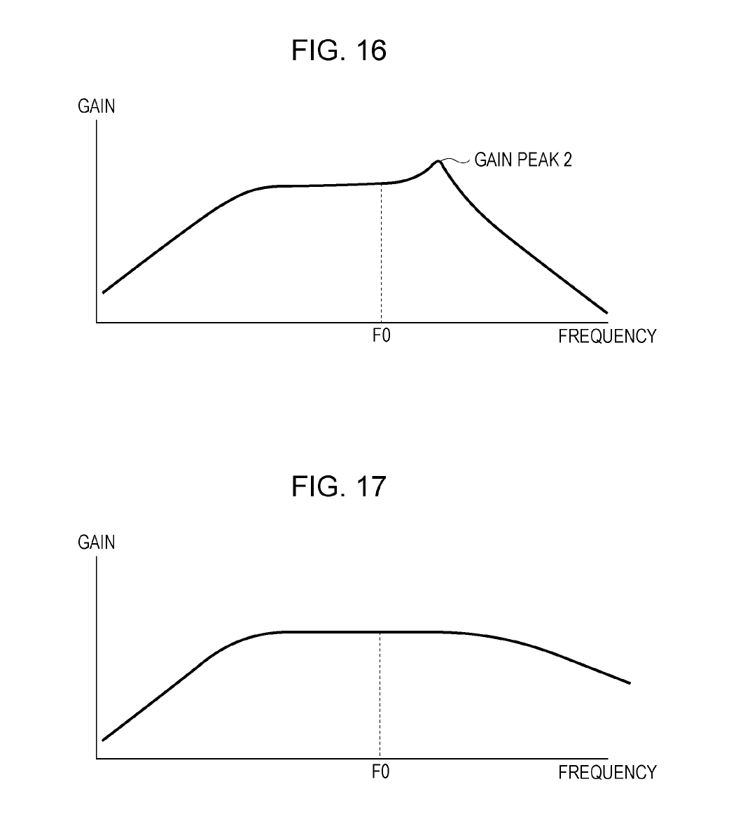

FIG. 15 illustrates Variation 2 of the driving circuit according to the present embodiment. The driving circuit in the present variation is the one in which resistors 44 and 45 are added in series to the primary sides of the transformers 40 and 41 in FIG. 12. FIG. 16 illustrates a frequency characteristic of a gain (that is, frequency response characteristic between the input and output of the transformer) from the input voltage Va to the output signal Da of the transformer 40 in the circuit illustrated in FIG. 12. The resistors disposed in series on the primary sides of the transformers 40 and 41 suppress the gain peaks 1 and 2, and the gain characteristic changes as illustrated in FIG. 16. FIG. 16 reveals that the gain peak 1 is not present and the gain peak 2 is suppressed. The resistors in FIG. 15 may be replaced with another resistance element, such as a posistor.

The reason why the gain peak 2 is present in FIG. 16 is that attenuation by the resistors is insufficient. Because large attenuation by the resistors leads to decreased efficiency, an approach to this issue can be a measure of reducing the leakage inductance of the transformer. FIG. 17 illustrates a gain characteristic when the leakage inductance is reduced by the use of a toroidal core in the transformer. As illustrated in FIG. 17, because the leakage inductance is reduced, the gain peak 2 is not present.

As described above, in the present embodiment, outputting a driving voltage to be applied to the vibration-type actuator from the linear amplifier enables a harmonic component contained in the driving voltage to be reduced, and thus noise of the harmonic component is suppressed. In addition, in the present embodiment, noise transmission from the power supply can be blocked by the use of the transformer, and the gain peak characteristic being a factor of the occurrence of noise can be suppressed. This enables stably driving the robotic arm that performs medical treatment and the like in cooperation with the MRI apparatus. The linear amplifier is less efficient than a switching amplifier, such as a D-class amplifier. The efficiency of the linear amplifiers 19 and 20 can be enhanced by making the resonant frequency determined by the secondary-side inductances of the transformers 40 and 41 and the damping capacitances of the piezoelectric members 15-a and 15-b substantially equal to the resonant frequency of the vibration-type actuator. For example, when the damping capacitance of the piezoelectric member is 7.8 nF, if the secondary-side inductance of the transformer is 3.4 mH, the resonant frequency is approximately 30.9 kHz. By setting this frequency in the vicinity of the driving frequency or the resonant frequency of the vibration-type actuator, the power consumption of the linear amplifier in the vicinity of the resonant frequency can be reduced.

Similar advantages are also obtainable when the driving circuit for the vibration-type actuator in the present embodiment is used in an apparatus disposed inside a magnetically shielded room other than the MRI apparatus.

### Third Embodiment

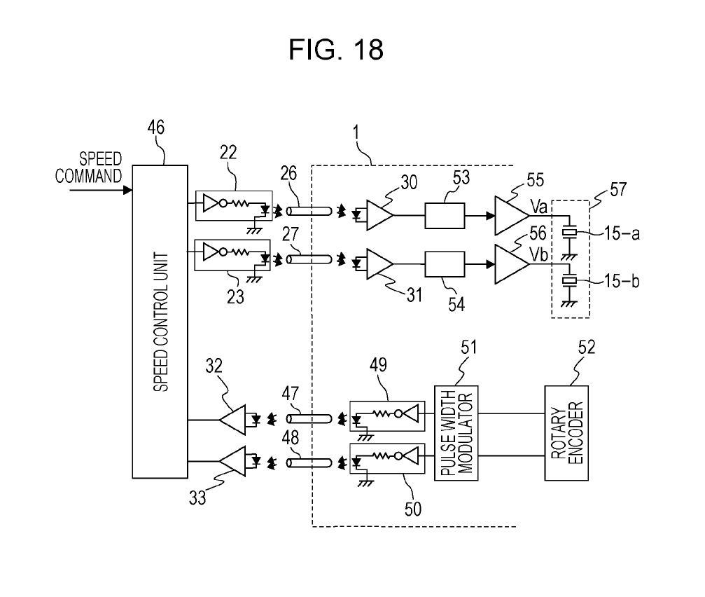

A third embodiment of the present application is described next. FIG. 18 illustrates a driving circuit for a vibration-type actuator according to the third embodiment. In the present embodiment, the inside and outside of the magnetically shielded room 1 are connected using optical fibers, and a driving signal for the vibration-type actuator and an encoder signal for use in detecting a rotation position are transmitted using optical signals.

A speed control unit 46 detects a rotation speed that indicates a driving state of a vibration-type actuator 57 from a rotary encoder 52 in response to a speed command from an output signal of a command unit (not illustrated), and controls any one of a frequency, amplitude, and phase of an alternating voltage to be applied to the vibration-type actuator 57. The speed control unit 46 is disposed inside the controller 8 illustrated in FIG. 1. That is, the speed control unit 46 is disposed outside the magnetically shielded room 1, and is connected to the inside of the magnetically shielded room 1 using an optical signal. Low-pass filters 53 and 54 receive pulse signals in which sine waves are pulse-width modulated, and remove harmonic components resulting from the pulse-width modulation from them. The signals, from which the harmonic components are removed, are input into linear amplifiers 55 and 56. Alternating voltages Va and Vb output from the linear amplifiers 55 and 56 are applied to the piezoelectric members 15-a and 15-b included in the vibration-type actuator 57.

The frequency, phase, and voltage amplitude of each of the alternating voltages Va and Vb are independently controllable in accordance with a pulse signal generated by the speed control unit 46. Thus, for example, periodically changing the voltage amplitude and phase with a predetermined pattern causes travelling oscillating waves in different directions to simultaneously occur in the ring elastic member of the vibration-type actuator 57 and enables the elastic member to be driven at very low speed. The used technique can be switched to various control techniques, such as a technique of controlling a force by changing the balance between travelling waves and standing waves. This enables the vibration-type actuator 57 to be smoothly driven, including an inverting operation, at from low speed to high speed and also enables a manipulator that requires fine force control to be driven.

The rotary encoder 52 is a speed detecting unit to detect a speed that indicates a driving state of the vibration-type actuator 57, and outputs a two-phase analog sinusoidal signal. The analog sinusoidal signal from the rotary encoder 52 is pulse-width modulated by a pulse-width modulator 51. In the present embodiment, the rotary encoder 52 and the pulse-width modulator 51 constitute a detecting unit. Transmitters 49 and 50 convert pulse signals output from the pulse-width modulator 51 into optical signals, and transmit the optical signals from the inside of the magnetically shielded room 1 to the receivers 32 and 33, which are disposed outside the magnetically shielded room 1, through optical fibers 47 and 48.

The speed control unit 46 measures the pulse width of each of pulse-width modulated signals from the receivers 32 and 33, and detects the waveform of an analog sinusoidal signal output from the rotary encoder 52. The speed control unit 46 determines the amount of movement within a predetermined time using the detection, and calculates the speed. Then, the speed control unit 46 compares this calculation with a speed command from the command unit (not illustrated), and determines the frequency, phase, and amplitude of each of the alternating voltages Va and Vb for driving the vibration-type actuator 57 in accordance with the comparison. The determined waveforms of the alternating voltages Va and Vb are promptly pulse-width modulated, and they are transmitted as optical signals to the driving circuit inside the magnetically shielded room 1 through the transmitters 22 and 23. Then, the vibration-type actuator 57 operates such that the rotation speed matches with the speed command.

In the present embodiment, four optical fibers are used. With the principle of optical wavelength multiplexing, the connection may also be achieved by a single optical fiber. The number of optical fibers can also be reduced even when a plurality of vibration-type actuators are used.

Advantages of the configuration in which a driving signal for the vibration-type actuator is transmitted as a pulse signal through an optical fiber are described here again. Because the speed control unit 46 measures the pulse width of a pulse-width modulated signal from the rotary encoder 52 and generates a sine-wave pulse-width modulated signal for driving the vibration-type actuator, it needs a counter with a reference clock of several tens to several hundred MHz. To make a plurality of vibration-type actuators operate in cooperation with one another, CPUs (controllers) for performing high-speed calculation to control a speed may be needed. Nowadays, these controllers are constructed using field-programmable gate arrays (FPGAs) or the like in many cases. Noise resulting from radio-frequency clocks is a great enemy to the MRI apparatus. In particular, when the vibration-type actuator operates inside the bore of the MRI apparatus, it is necessary to avoid noise from mixing into the vibration-type actuator. To address this issue, placing the portion operating with a radio-frequency clock outside the magnetically shielded room 1 and transmitting signals into the magnetically shielded room 1 using optical fibers, as in the present embodiment, can provide an advantage of avoiding noise resulting from the radio-frequency clock from occurring inside the magnetically shielded room 1.

In addition, connecting a driving signal for the vibration-type actuator and an encoder signal to a remote site using an optical fiber enables real-time control because, even for complicated waveform control, substantially no transmission delay occurs. Recently, an inexpensive FPGA of a large size with high computing performance has been available. Thus even for an application that requires sophisticated computation, such as complicated waveform control or model prediction, a large number of processing can be concurrently performed using a single FPGA. The use of an optical fiber can handle noisy environment, such as a factory, when the embodiments are used in an apparatus that measures noise in a product. Thus a configuration in which the control sections for many vibration-type actuators are integrated into a single FPGA and only the driving circuits for the vibration-type actuators are distributed can achieve an inexpensive application that performs sophisticated control using many vibration-type actuators.

According to the present invention, outputting a driving voltage to be applied to a vibration-type actuator by the use of a linear amplifier enables a harmonic component contained in the driving voltage to be reduced, and noise of the harmonic component is suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-135447 filed Jun. 15, 2012, which is hereby incorporated by reference herein in its entirety.

What is claimed is:

1. A driving device for a vibration-type actuator disposed in a magnetically shielded room, the driving device comprising:
a linear amplifier configured to receive a signal based on a driving waveform for driving the vibration-type actuator and output a driving voltage to be applied to the vibration-type actuator.

2. The driving device according to claim 1, further comprising a filter configured to receive the driving waveform,
wherein the linear amplifier is configured to receive the signal based on the driving frequency output from the filter.

3. The driving device according to claim 2, wherein the filter is a low-pass filter.

4. The driving device according to claim 1, wherein the linear amplifier has a filter characteristic.

5. The driving device according to claim 1, further comprising a transformer,
wherein the transformer has a primary side connected to the linear amplifier and a secondary side connected to the vibration-type actuator, and
the driving voltage output from the linear amplifier is applied to the vibration-type actuator through the transformer.

6. The driving device according to claim 5, further comprising a capacitor connected in series to the primary side of the transformer.

7. The driving device according to claim 5, further comprising a resistor connected in series to the primary side of the transformer.

8. The driving device according to claim 1, wherein the linear amplifier is configured to receive a sine wave as the signal based on the driving waveform.

9. The driving device according to claim 8, wherein the linear amplifier is configured to receive an analog signal containing a modulation frequency component of a pulse signal in which a sine wave is pulse-width modulated or pulse-amplitude modulated as the signal based on the driving waveform.

10. The driving device according to claim 1, wherein the linear amplifier is configured to receive a pulse signal in which a sine wave is pulse-modulated as the signal based on the driving signal.

11. The driving device according to claim 1, wherein the linear amplifier is configured to receive a signal in which a sine wave is digital-to-analog converted as the signal based on the driving signal.

12. A medical system comprising:
the vibration-type actuator and the driving device for the vibration-type actuator according to claim 1;
a receiving portion configured to receive an electromagnetic wave from a subject; and
a waveform generating unit configured to generate the driving waveform,
wherein at least the vibration-type actuator, the driving device, and the receiving portion are disposed inside the magnetically shielded room, and
the waveform generating unit is disposed inside or outside the magnetically shielded room.

13. The medical system according to claim 12, wherein the driving waveform generated by the waveform generating unit is a pulse signal in which a sine wave is pulse-width modulated or pulse-amplitude modulated, and a frequency that is an integer multiple of a modulation frequency of the pulse signal does not overlap a Larmor frequency range.

14. The medical system according to claim 13, wherein the driving waveform generated by the waveform generating unit is a signal in which a sine wave is digital-to-analog converted, and a frequency that is an integer multiple of a sampling frequency of the D/A conversion does not overlap the Larmor frequency range.

15. The medical system according to claim 12, wherein the driving waveform generated by the waveform generating unit is a pseudo sine wave containing a harmonic, and the harmonic does not overlap a Larmor frequency range.

16. The medical system according to claim 12, wherein the waveform generating unit is configured to convert the driving waveform into an optical signal,
the medical system further comprising:
an optical transmission unit configured to transmit the optical signal from the outside of the magnetically shielded room to the inside of the magnetically shielded room; and
a photoreceiver configured to receive the optical signal and convert the optical signal into an electrical signal.

17. A driving device for a vibration-type actuator disposed in a magnetically shielded room,
wherein the driving device is configured to receive a signal based on a driving waveform for driving the vibration-type actuator and output a waveform generated based on a sine wave as a driving voltage to be applied to the vibration-type actuator.
